(19) United States
(12) Patent Application Publication
(10) Pub. No.: US 2009/0072115 A1
(43) Pub. Date: Mar. 19, 2009

(54) Wind-resistant sign assembly

(76) Inventor: Mack Worley, Okeechobee, FL (US)

Correspondence Address: The Intellect Law Group, 901 SW Martin Downs Blvd., Suite 321, Palm City, FL, 34990, US

(21) Appl. No.: 11/855,118

(22) Filed: Sep. 13, 2007

(51) Int. Cl. F16M 13/02; E01F 9/018

(52) U.S. Cl. 248/548; 403/2

(57) ABSTRACT

A signpost, sign and a coupling mechanism for connecting the sign and signpost. The coupling mechanism incorporates a replaceable shear pin of appropriate material and strength so as to facilitate shearing of the pin in high wind conditions, thereby unlocking the coupling mechanism and allowing the sign to rotate freely about the axis of the signpost. The invention, as described, safely contains a sign attached to a signpost while reducing the possibility of wind forces damaging the sign and/or sign and signpost combination.

### FIELD OF THE INVENTION

This invention relates to an apparatus and assembly for mounting a sign to a pole.

### SUMMARY OF THE INVENTION

An object of the present invention is to provide a coupling mechanism to secure a sign to a post.

A further object of the present invention is to provide a means to secure a sign to a post in a manner which minimizes the risk of damage in high wind conditions.

A still further object of the present invention is to provide a coupling mechanism which can be returned to service after a high wind condition event with minimal labor and cost.

Other objects and advantages of the invention will be apparent from the following description, the accompanying drawings and the appended claims.

### BRIEF DESCRIPTION OF THE DRAWINGS

FIG. 1 depicts a perspective view of an embodiment of the present invention;

FIG. 2 shows a side view of an embodiment of a sign ring coupling mechanism;

FIG. 3 shows a top view of an embodiment of a sign ring coupling mechanism;

FIG. 4 shows a side view of an embodiment of a post ring coupling mechanism.

FIG. 5 shows a top view of an embodiment of a post ring coupling mechanism; and

FIG. 6 shows an embodiment of a shear pin.

FIG. 7 is a side view of the sign ring, post ring and shear pin with the shear pin installed.

### DETAILED DESCRIPTION OF THE INVENTION

The present invention describes a signpost (100), sign (102) and coupling mechanism comprising a sign ring (104), a post ring (106) and a shear pin (108) for connecting the sign and signpost. The coupling mechanism incorporates a pair of first and second sign rings (104, 105) and a pair of first and second post rings (106, 107) each encircling a signpost (100). In the invention, the first and second post rings (106, 107) are attached to the signpost (100) and corresponding first and second sign rings (104, 105) are attached to the sign (102). Each post ring has a corresponding sign ring, each containing holes (110) aligned for the insertion of a shear pin (108) of appropriate material and strength. The shear pin is placed through both the post ring and its corresponding sign ring, locking the rings into axial position relative to each other. A first post ring (106) is positioned atop a first sign ring (104) on an upper mounting position of the signpost (100) and a second post ring (107) is positioned below a second sign ring (105) on a lower mounting position of the signpost (100), thereby locking the vertical position of the sign (102) relative to the signpost (100). The sign is laterally offset from the centerline of the signpost so as to facilitate shearing of the shear pin (108) in high wind conditions, thereby unlocking the sign rings from the post rings and allowing the sign to rotate freely about the axis of the signpost. The invention, as described, safely contains a sign attached to a signpost while reducing the possibility of wind forces damaging the sign and/or sign and signpost combination. The shear pin is easily and inexpensively replaced without any need for heavy labor in replacing or handling the signpost or sign. The invention is easily and inexpensively adapted to existing sign and signpost combinations and may be used unobtrusively with other signpost mechanisms designed to allow breakaway signposts in the event of vehicle collision.

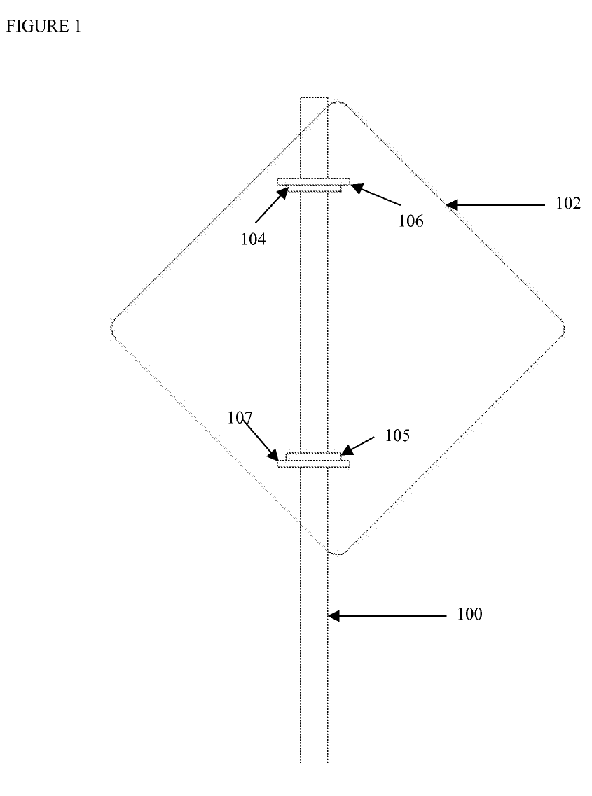

FIG. 1 depicts a signpost, sign and coupling mechanism for connecting the sign and signpost consisting of first and second sign rings, first and second corresponding post rings and shear pins.

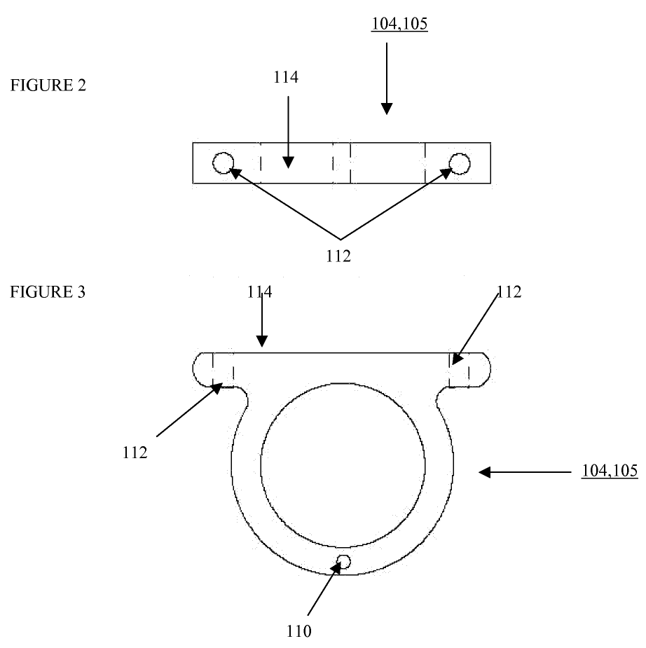

FIG. 2 depicts a side view of an embodiment of a sign ring indicating the sign mounting surface (114). Bolt holes (112) for the insertion of bolts and securing nuts are depicted in the embodiment as one means of securing the sign ring to the sign. Alternative securing means such as adhesives, welds or other mechanical fasteners may be substituted as appropriate for the application.

FIG. 3 depicts a top view of an embodiment of a sign ring indicating the sign mounting surface (114), signpost gripping surface (116) and shear pin hole (110) for coupling with a corresponding post ring.

FIG. 4 depicts a side view of an embodiment of a post ring indicating setscrew holes (118) to accommodate setscrews to positionally affix the post ring to the signpost. Alternative means to affix the post ring to the signpost may include adhesives, welds or other mechanical fasteners such as screws or bolts, which may be substituted as appropriate for the application.

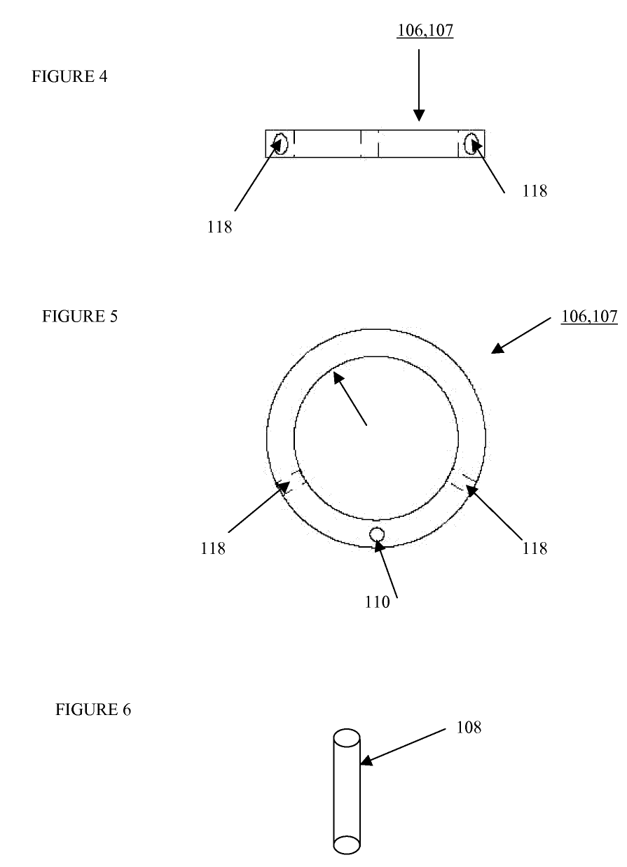

FIG. 5 depicts a top view of an embodiment of a post ring indicating the signpost gripping surface (120), setscrew holes (118) and shear pin hole (110) for coupling with a corresponding sign ring.

FIG. 6 depicts an embodiment of a shear pin (108), constructed of a suitable material to provide a shearing resistance appropriate to the application.

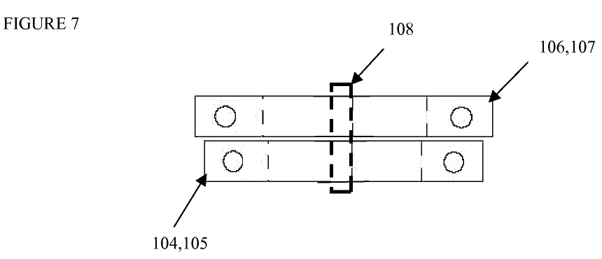

FIG. 7 shows the relationship between the sign ring (104,105) , post ring (106, 107) and shear pin (108) with the shear pin installed. The shear pin locks the sign ring and post ring in axial relation to each other. The shear pin is not required to extend from either end of the joined rings but is pictured as such solely for ease of visual clarity and identification.

Although preferred embodiments of the system and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A signpost, sign and coupling mechanism for connecting the sign and signpost comprising:
a signpost, sign, first and second sign rings and first and second post rings, all the rings encircling the signpost with the first and second sign rings affixed to the sign and the first and second post rings affixed to the signpost.

2. The signpost, sign and coupling mechanism of claim 1 wherein the sign is laterally offset from the centerline of the signpost

3. The signpost, sign and coupling mechanism of claim 1 wherein a first post ring is positioned above a first sign ring on an upper mounting position and a second post ring is positioned below a second sign ring on a lower mounting position, thereby locking the vertical position of the sign relative to the signpost.

4. The signpost, sign and coupling mechanism of claim 1 wherein a post ring and a sign ring each contain holes for the insertion of a shear pin, and further comprising a shear pin where said shear pin is positioned longitudinally with the signpost and locking the rings into axial position relative to each other.

5. The signpost, sign and coupling mechanism of claim 4 wherein the shear pin is user-replaceable.

6. The signpost, sign and coupling mechanism of claim 3 wherein the first post ring and first sign ring are coupled together using a shear pin positioned longitudinally with the signpost locking the rings into axial position relative to each other.

7. The signpost, sign and coupling mechanism of claim 3 wherein the second post ring and second sign ring are coupled together using a shear pin positioned longitudinally with the signpost locking the rings into axial position relative to each other.

8. A coupling mechanism for connecting a sign and a signpost comprising:
first and second sign rings and first and second post rings, all the rings capable of encircling a signpost with the first and second sign rings having means to be affixed to a sign and the first and second post rings having means to be affixed to a signpost.

9. The coupling mechanism of claim 8 wherein a first post ring is positioned above a first sign ring on an upper mounting position and a second post ring is positioned below a second sign ring on a lower mounting position, so as to lock the vertical position of the sign relative to the signpost.

10. The coupling mechanism of claim 8 wherein each post ring and each sign ring contain holes for the insertion of a shear pin positioned longitudinally with the signpost and for locking the rings into axial position relative to each other.

11. The coupling mechanism of claim 10 including a shear pin.

12. The coupling mechanism of claim 9 wherein the first post ring and first sign ring are coupled together using a shear pin positioned longitudinally with the signpost and locking the rings into axial position relative to each other.

13. The coupling mechanism of claim 9 wherein the second post ring and second sign ring are coupled together using a shear pin positioned longitudinally with the signpost locking the rings into axial position relative to each other.
